(19) United States
(12) Patent Application Publication
(10) Pub. No.: US 2016/0368810 A1
(43) Pub. Date: Dec. 22, 2016

(54) CUTTING WHEEL FOR CUTTING BRITTLE MATERIAL

(71) Applicants: BOE TECHNOLOGY GROUP CO., LTD., Beijing (CN); BOE (Hebei) Mobile Display Technology Co., Ltd., GuAn (CN)

(72) Inventor: Pingjun Wang, Beijing (CN)

(21) Appl. No.: 15/095,694

(22) Filed: Apr. 11, 2016

(30) Foreign Application Priority Data
Jun. 17, 2015 (CN) 201510338864.9

(51) Int. Cl. C03B 33/10; B26D 3/08

(52) U.S. Cl. CPC C03B 33/107; B26D 3/08

(57) ABSTRACT

Embodiments the invention disclose a cutting wheel, which includes: a wheel body; and a plurality of teeth formed on the wheel body, wherein each of the teeth includes a first auxiliary edge, a main edge and a second auxiliary edge that connect with each other successively. The main edge, the first auxiliary edge and the second auxiliary edge lie in the same plane, and inclined surfaces for forming the main edge, the first auxiliary edge and the second auxiliary edge respectively and located at the same side of the plane connect with each other successively. A recessed region is formed between main edges of two adjacent teeth, and a first auxiliary edge of one of the two adjacent teeth and a second auxiliary edge of the other of the two adjacent teeth are located within the recessed region.

### CROSS-REFERENCE TO RELATED APPLICATION

This application claims the benefits of Chinese Patent Application No. 201510338864.9 filed on Jun. 17, 2015 in the State Intellectual Property Office of China, whole disclosures of which is incorporated herein by reference.

### TECHNICAL FIELD

Embodiments of the invention relate to a cutting wheel, and specifically, to a cutting wheel for cutting a brittle material.

### BACKGROUND

Cutting wheels are common tools for cutting brittle materials such as glass and the like. A cutting wheel may form a cutting line on a surface of a brittle material, so as to facilitate fracture of the brittle material alone the cutting line. A conventional structure of a cutting wheel comprises a wheel body and a plurality of teeth formed on the wheel body, and each teeth is formed with an edge for cutting glass.

During cutting, a cutting wheel applies and maintains a certain pressure on a surface of a brittle material and rolls on the surface of the brittle material. Edges at top of the teeth are pressed into the surface of the brittle material under the pressure, forming a cutting line. FIG. 1 shows a conventional cutting wheel in prior art, which comprises a wheel body 01 provided with a plurality of teeth 02 distributed successively. Edges of the teeth 02 on the wheel body 01 form a plurality of separate rectangular cutting indentations distributed successively on a surface of glass, as shown in FIG. 2. Since a rectangular cutting indentation has four sharp corners, during cutting or during fracture of the brittle material, it is easy to form, at the four corners of the rectangular shape, microcracks 03 that extend outwards due to extension property of the crack in the brittle material, as shown in FIG. 3, such that, fracturing performance and product yield rate of cutting the brittle material are decreased. During use of a product formed of a brittle material, edge regions of the product have a low mechanical strength, and thereby product stability is reduced.

### SUMMARY

The present invention has been made to overcome or alleviate at least one aspect of the above mentioned disadvantages.

Embodiments of the invention provide a cutting wheel for cutting a brittle material, which may enhance uniformity and continuity of a cutting line, improve fracturing performance and product yield rate of cutting the brittle material, increase mechanical strength at edge regions of a product made of the brittle material, and in turn increase product stability in use.

To achieve the above object, a cutting wheel is provided.

According to an embodiment of the invention, the cutting wheel comprises a wheel body and a plurality of teeth formed on the wheel body, each of the teeth comprises a first auxiliary edge, a main edge and a second auxiliary edge that connect with each other successively, wherein the main edge, the first auxiliary edge and the second auxiliary edge lie in the same plane, and inclined surfaces forming the main edge, the first auxiliary edge and the second auxiliary edge respectively and located at the same side of the plane connect with each other successively; and wherein a recessed region is formed between main edges of two adjacent teeth, and the first auxiliary edge of one of the two adjacent teeth and the second auxiliary edge of the other of the two adjacent teeth are located within the recessed region.

Thus, when cutting a brittle material with the cutting wheel above, a continuous cutting impression is formed, and parts of the cutting impression connect with each other via smooth transitions, and in turn, microcracks formed due to sharp corners of a cutting impression can be reduced. Thus, fracturing performance and product yield rate of cutting the brittle material are improved and mechanical strength at edge regions of a product made of the brittle material is increased, and in turn product stability is improved in use.

### BRIEF DESCRIPTION OF THE DRAWINGS

The above and other features of the present invention will become more apparent by describing in detail exemplary embodiments thereof with reference to the accompanying drawings, in which:

FIG. 1 is a structural drawing showing a cutting wheel in prior art;

FIG. 2 is a schematic drawing showing cutting impressions on a surface of a brittle material formed by the cutting wheel shown in FIG. 1;

FIG. 3 is a partially enlarged schematic drawing showing a cutting impression shown in FIG. 2;

FIG. 4 is a schematic drawing showing a structure of a cutting wheel according to an embodiment of the invention;

FIG. 5 is a schematic drawing showing teeth of a cutting wheel according to an embodiment of the invention, in which two adjacent teeth are shown;

FIG. 6 is a schematic drawing showing cutting impressions on a surface of a brittle material formed by the teeth of the cutting wheel shown in FIG. 5;

FIG. 7 is a partially enlarged schematic drawing showing a cutting impression shown in FIG. 6;

FIG. 8 is a schematic drawing showing a tooth according to another embodiment of the invention;

FIG. 9 is a schematic drawing showing a tooth according to a further embodiment of the invention;

FIG. 10 is a schematic drawing showing a tooth according to a still further embodiment of the invention; and

FIG. 11 is a schematic drawing showing a tooth according to a still further embodiment of the invention.

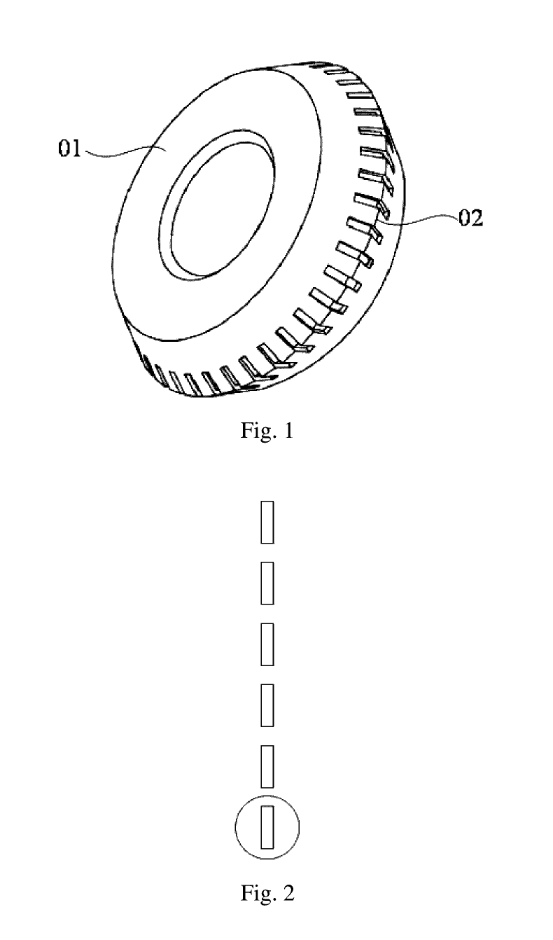

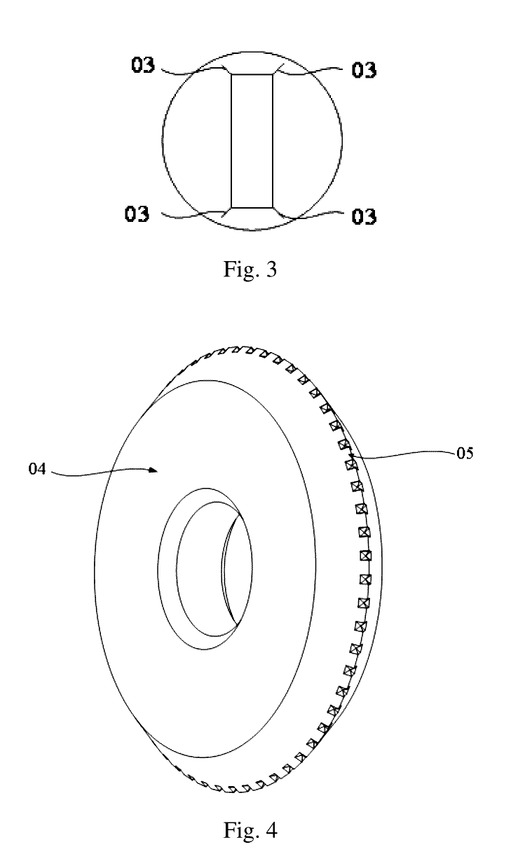

### DETAILED DESCRIPTION OF PREFERRED EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

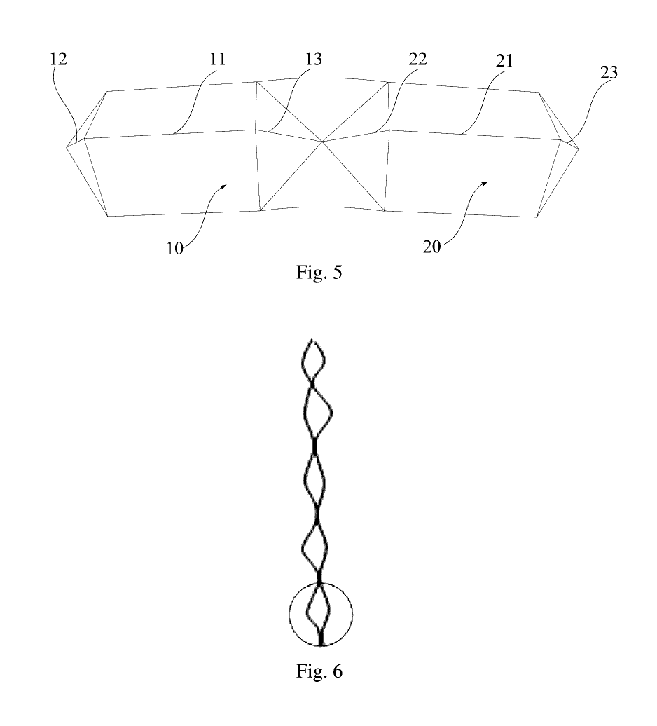

FIG. 4 schematically shows a structure of a cutting wheel according to one embodiment of the invention. As shown in FIG. 4, the cutting wheel comprises a wheel body 04 and a plurality of teeth 05 formed on the wheel body 04. FIG. 5 schematically shows teeth of the cutting wheel according to the embodiment, in which two adjacent teeth are shown. As shown in the figures, a left-side tooth 10 comprises a first auxiliary edge 12, a main edge 11 and a second auxiliary edge 13 connected successively. The main edge 11, the first auxiliary edge 12 and the second auxiliary edge 13 lie in the same first plane, and inclined surfaces forming the main edge 11, the first auxiliary edge 12 and the second auxiliary edge 13 respectively and located at the same side of the first plane connect with each other successively. A right-side tooth 20 located adjacent to the left-side tooth 10 comprises a first auxiliary edge 22, a main edge 21 and a second auxiliary edge 23 connected successively. The main edge 21, the first auxiliary edge 22 and the second auxiliary edge 23 lie in the same second plane, and inclined surfaces forming the main edge 21, the first auxiliary edge 22 and the second auxiliary edge 23 respectively and located at the same side of the second plane connect with each other successively. A recessed region is formed between the main edges 11, 21 of the adjacent left-side and right-side teeth 10, 20, and the first auxiliary edge 22 of the right-side tooth 20 and the second auxiliary edge 13 of the left-side tooth 10 are located within the recessed region. A distribution of the teeth on the wheel body is shown in FIG. 4, and the teeth are distributed successively along a circumferential direction of the wheel body. The cutting wheel shown in FIG. 4 may be used for cutting brittle materials.

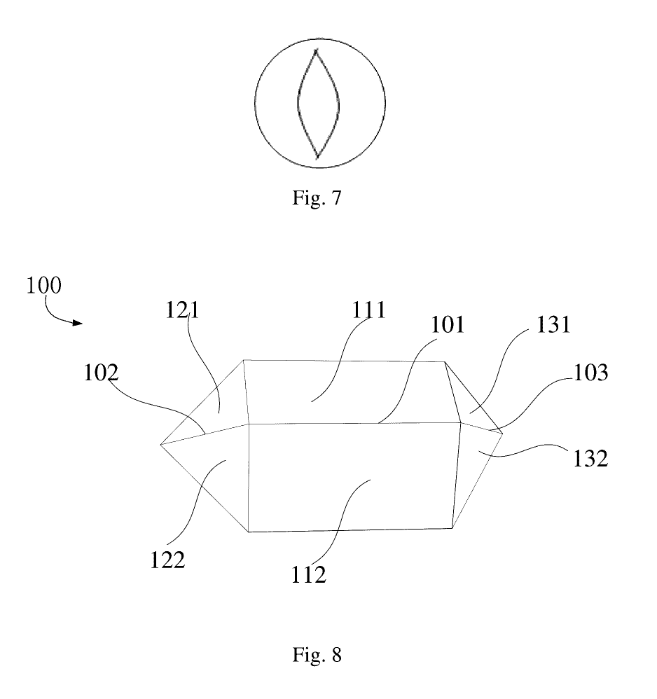

In the cutting wheel above, for every two adjacent teeth, such as the left-side tooth 10 and the right-side tooth 20 shown in FIG. 5, since the left-side tooth 10 comprises the main edge 11, the first auxiliary edge 12 and the second auxiliary edge 13 connected successively, the right-side tooth 20 comprises the main edge 21, the first auxiliary edge 22 and the second auxiliary edge 23 connected successively, and the first auxiliary edge 22 of the right-side tooth 20 and the second auxiliary edge 13 of the left-side tooth 10 are located within the recessed region, when cutting with the cutting wheel, for example, after the main edge 11 (or main edge 21) cuts into a brittle material, the first auxiliary edge 12 and the second auxiliary edge 12 (or the first auxiliary edge 22 and the second auxiliary edge 22) immediately cut into the brittle material for cutting the brittle material. Since the inclined surfaces forming the main edge 11, the first auxiliary edge 12 and the second auxiliary edge 13 respectively and located at the same side of the first plane connect with each other successively, and the inclined surfaces forming the main edge 21, the first auxiliary edge 22 and the second auxiliary edge 23 respectively and located at the same side of the second plane connect with each other successively, after the main edge 11, the first auxiliary edge 12 and the second auxiliary edge 13 of the left-side tooth 10 (or the main edge 21, the first auxiliary edge 22 and the second auxiliary edge 23 of the right-side tooth 20) have cut into the brittle material, a cutting impression formed by the main edge 11 is connected with cutting impressions formed by the first auxiliary edge 12 and the second auxiliary edge 13 via smooth transitions (or, a cutting impression formed by the main edge 21 is connected with cutting impressions formed by the first auxiliary edge 22 and the second auxiliary edge 23 via smooth transitions). Moreover, for every two adjacent teeth, the second auxiliary edge 13 of the left-side tooth 10 is connected with the first auxiliary edge 22 of the right-side tooth 20. Thus, the cutting impressions formed on the brittle material by the above cutting wheel form a continuous cutting impression having smooth transitions, as shown in FIGS. 6 and 7. FIG. 6 shows a continuous cutting impression after being cut by a plurality of teeth, and FIG. 7 is a partially enlarged schematic view showing a part of the continuous impression shown in FIG. 6 formed by one teeth. It is noted that respective impressions may have different shapes, which depend on shapes of the teeth that may be set as desired and will be described in detail below.

As stated above, when cutting the brittle material with the cutting wheel above, a continuous cutting impression is formed, and respective parts of the cutting impression connect with each other via smooth transitions, and in turn, microcracks formed due to sharp corners of a cutting impression can be reduced. Thus, fracturing performance and product yield rate of cutting the brittle material are improved and mechanical strength at edge regions of a product made of the brittle material is increased, and in turn product stability is improved in use.

FIG. 8 is a schematic drawing showing a tooth according to another embodiment of the invention. As shown in FIG. 8, a tooth 100 comprises: a main edge 101, a first auxiliary edge 102 and a second auxiliary edge 103; a first inclined surface 111 and a second inclined surface 112 located symmetrically at two sides of the main edge 101 respectively, the first inclined surface 111 and the second inclined surface 112 connecting with each other at the main edge 101; a third inclined surface 121 and a fourth inclined surface 122 located symmetrically at two sides of the first auxiliary edge 102 respectively, the third inclined surface 121 and the fourth inclined surface 122 connecting with each other at the first auxiliary edge 102; and a fifth inclined surface 131 and a sixth inclined surface 132 located symmetrically at two sides of the second auxiliary edge 103 respectively, the fifth inclined surface 131 and the sixth inclined surface 132 connecting with each other at the second auxiliary edge 103.

In the above cutting wheel, a shape of the tooth 100 can be defined by defining a distribution of the first, second, third, fourth, fifth and sixth inclined surfaces 111, 112, 121, 122, 131, 132, and thereby a desired cutting impression can be obtained. For example, in different embodiments: the first inclined surface 111 and the second inclined surface 112 that form the main edge 101 are distributed symmetrically at two sides of the main edge 101 respectively; and/or, the third inclined surface 121 and the fourth inclined surface 122 that form the first auxiliary edge 102 are distributed symmetrically at two sides of the first auxiliary edge 102 respectively; and/or, the fifth inclined surface 131 and the sixth inclined surface 132 that form the second auxiliary edge 103 are distributed symmetrically at two sides of the second auxiliary edge 103 respectively.

That is to say, the first inclined surface 111 and the second inclined surface 112 that form the main edge 101 may be distributed asymmetrically, the third inclined surface 121 and the fourth inclined surface 122 that form the first auxiliary edge 102 may be distributed asymmetrically, and/or the fifth inclined surface 131 and the sixth inclined surface 132 that form the second auxiliary edge 103 may also be distributed asymmetrically.

In other embodiments, a desired cutting impression can be obtained through defining the type or shape of each of the first, second, third, fourth, fifth and sixth inclined surfaces. Specifically, any one of the first, second, third, fourth, fifth and sixth inclined surfaces may be a planar surface, an inward concave surface or an outward convex surface.

In other embodiments, a desired cutting impression can be obtained through defining shapes of the main edge, the first auxiliary edge and the second auxiliary edge. Specifically, at least one of the main edge, the first auxiliary edge and the second auxiliary edge may have a shape in a form of a straight line, a shape in a form of an outward convex curved line or a shape in a form of an inward concave curved line.

In the embodiment shown in FIG. 8, each of the first, second, third, fourth, fifth and sixth inclined surfaces 111, 112, 121, 122, 131, 132 is a planar surface, and each of the main edge 101, the first auxiliary edge 102 and the second auxiliary edge 103 has a shape in a form of a straight line.

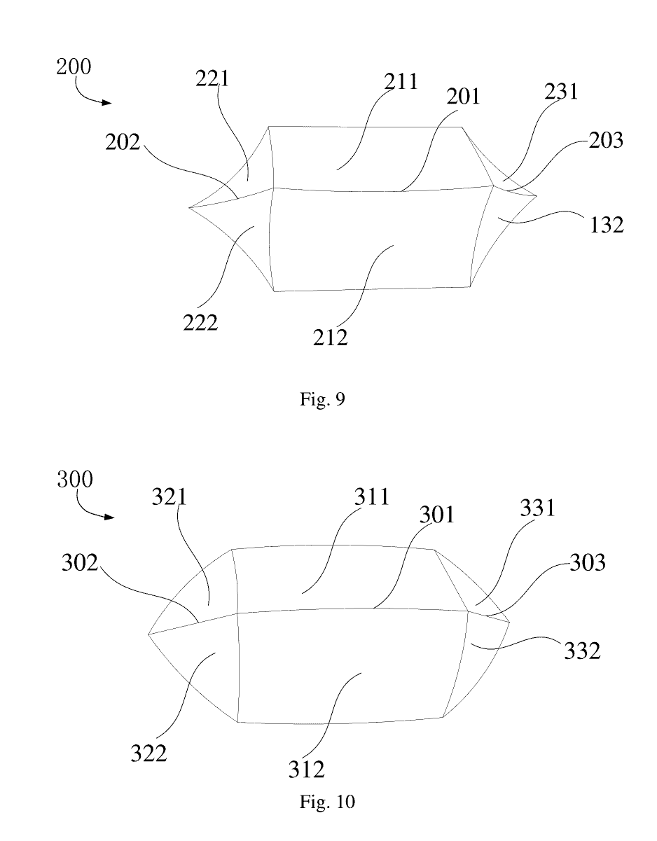

In an embodiment shown in FIG. 9, each of first, second, third, fourth, fifth and sixth inclined surfaces 211, 212, 221, 222, 231, 232 of a tooth 200 is an inward concave surface, and each of main edge 201, first auxiliary edge 202 and second auxiliary edge 203 has a shape in a form of as inward concave curved line.

In an embodiment shown in FIG. 10, each of first, second, third, fourth, fifth and sixth inclined surfaces 311, 312, 321, 322, 331, 332 of a tooth 300 is an outward convex surface, and each of main edge 301, first auxiliary edge 302 and second auxiliary edge 303 has a shape in a form of an outward convex curved line.

In an embodiment shown in FIG. 10, in order to improve smoothness of a cutting impression on a surface of the brittle material formed by the cutting wheel, a first inclined surface 411 connects with a third inclined surface 421 of a tooth 400 via a smooth transition, and the first inclined surface 411 connects with a fifth inclined surface 431 via a smooth transition; a second inclined surface 412 connects with a fourth inclined surface 422 via a smooth transition, and the second inclined surface 412 connects with a sixth inclined surface 432 via a smooth transition; a main edge 401 connects with a first auxiliary edge 402 via a smooth transition, and the main edge 401 connects with a second auxiliary edge 403 via a smooth transition.

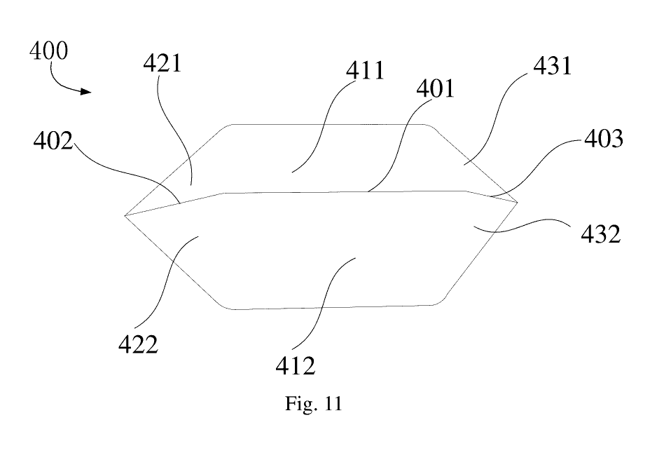

With the cutting wheel according to the embodiment shown in FIG. 11, smoothness of a cutting impression on the surface of the brittle material formed by the cutting wheel may be further improved, thus, microcracks caused by sharp corners of the cutting impression can be reduced, such that fracturing performance and product yield rate of cutting the brittle material are improved and mechanical strength at edge regions of a product made of the brittle material is increased, and in turn product stability is improved in use.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A cutting wheel, comprising:
a wheel body; and
a plurality of teeth formed on the wheel body, each of the teeth comprising a first auxiliary edge, a main edge and a second auxiliary edge that connect with each other successively,
wherein the main edge, the first auxiliary edge and the second auxiliary edge lie in the same plane, and inclined surfaces forming the main edge, the first auxiliary edge and the second auxiliary edge respectively and located at the same side of the plane connect with each other successively, and
wherein a recessed region is formed between main edges of two adjacent teeth, and a first auxiliary edge of one of the two adjacent teeth and a second auxiliary edge of the other of the two adjacent teeth are located within the recessed region.

2. The cutting wheel according to claim 1, wherein each of the teeth comprises a first inclined surface and a second inclined surface symmetrically distributed with respect to the plane and connected with each other at the main edge.

3. The cutting wheel according to claim 2, wherein each of the teeth further comprises a third inclined surface and a fourth inclined surface symmetrically distributed with respect to the plane and connected with each other at the first auxiliary edge.

4. The cutting wheel according to claim 3, wherein each of the teeth further comprises a fifth inclined surface and a sixth inclined surface symmetrically distributed with respect to the plane and connected with each other at the second auxiliary edge.

5. The cutting wheel according to claim 4, wherein each of the first inclined surface, the second inclined surface, the third inclined surface, the fourth inclined surface, the fifth inclined surface and the sixth inclined surface comprises a planar surface, an inward concave surface, or an outward convex surface.

6. The cutting wheel according to claim 5, wherein the first inclined surface, the third inclined surface and the fifth inclined surface are located at one side of the plane, and the second inclined surface, the fourth inclined surface and the sixth inclined surface are located at the other side of the plane;
wherein the first inclined surface and the third inclined surface are connected with each other via a smooth transition, and/or the first inclined surface and the fifth inclined surface are connected with each other via a smooth transition; and
wherein the second inclined surface and the fourth inclined surface are connected with each other via a smooth transition, and/or the second inclined surface and the sixth inclined surface are connected with each other via a smooth transition.

7. The cutting wheel according to claim 1, wherein the inclined surfaces located at the same side of the plane are connected with each other via smooth transitions.

8. The cutting wheel according to claim 1, wherein at least one of the main edge, the first auxiliary edge and the second auxiliary edge of each of the teeth has a shape in a form of a straight line, a shape in a form of an outward convex curved line or a shape in a form of an inward concave curved line.

9. The cutting wheel according to claim 1, wherein the main edge is connected with the first auxiliary edge via a smooth transition, and/or the main edge is connected with the second auxiliary edge via a smooth transition.
